(19) United States
(12) Patent Application Publication
(10) Pub. No.: US 2011/0295991 A1
(43) Pub. Date: Dec. 1, 2011

(54) Network system, controller, and network control method

(75) Inventor: Takafumi Aida, Tokyo (JP)

(73) Assignee: NEC CORPORATION, Tokyo (JP)

(21) Appl. No.: 13/137,348

(22) Filed: Aug. 8, 2011

Related U.S. Application Data
(63) Continuation of application No. PCT/JP2011/051360, filed on Jan. 25, 2011.

(30) Foreign Application Priority Data
Feb. 1, 2010 (JP) 2010-020391

(51) Int. Cl. G06F 15/173

(52) U.S. Cl. 709/223

(57) ABSTRACT

A network system includes appliances provided in a network; a switch provided in the network; and a controller connected to the appliances and the switch. The switch contains a flow table. Entries in the flow table each specify an action to be performed on a packet matching with a matching condition. Upon receiving a packet, the switch refers to the flow table and performs the action specified by matching one of the entries which matches the received packet, on the received packet. A first appliance of the appliances performs a first packet process on a packet belonging to an existing flow, when being selected as an active appliance. When the active appliance is switched from the first appliance to a second appliance of the appliances, the controller performs a switching process after performing a shortcut process. In the shortcut process, the controller instructs the switch to set a first entry into the flow table, the first entry specifying that the first packet process is to be performed on a packet belonging to the existing flow. In the switching process, the controller instructs the switch to set a second entry into the flow table, the second entry specifying that a packet which is addressed to the active appliance and belongs to a new flow other than the existing flow is to be transferred to the second appliance.

### CROSS-REFERENCE TO RELATED APPLICATION

This is a continuation of International Application No. PCT/JP2011/051360, filed on Jan. 25, 2011.

### BACKGROUND OF THE INVENTION

1. Field of the Invention

The present invention relates to a technique for controlling a network system that includes an appliance. In particular, the present invention relates to a technique for switching appliances to be used.

2. Description of the Related Art

An appliance (network appliance) is a network apparatus specialized for a particular function, which is introduced into a network. Examples of an appliance include a load balancer and a firewall.

A load balancer provides the function of a load distribution. In detail, a load balancer is recognized as a virtual server from an external network, and a client issues a request by specifying a virtual IP address (VIP) and a port number which correspond to this virtual server. The load balancer selects one real server which actually provides a service to a client from a plurality of real servers that are previously associated with the virtual server. Then, the load balancer rewrites the destination address in a requesting packet (for example, a MAC address or both of the MAC address and the IP address) to that of the selected real server, and transfers the request to the real server.

A firewall provides the function of ensuring the security through the communication control. In detail, a firewall passes or discards a packet on the basis of conditions of the IP address, the port number and the like. Also, a control may be implemented in which only response packets for packets which have been passed are passed. In this way, the firewall manages the states of connections and sessions to strongly ensure the security.

Here, let us consider switching of appliances to be used. For example, let us consider a case in which an appliance which is being used is stopped for maintenance and the like and its function is reassigned to another appliance. At this time, when the appliances are merely switched, some or all of the sessions using the appliance which is effective before the switching are disconnected. This is because session information held in the appliance is not handed over. In a load balancer, for example, session information indicates which client is accommodated by which real server. When the session information is not handed over, the existing sessions are treated similarly to new sessions, and this results in that the existing sessions may be transferred to a real server differing from the original server. As another example, let us consider a firewall that is set to pass only the response packet to an already-passed packet. Also in this case, when the session information is not handed over to the firewall to which the session is reassigned, a response packet is discarded, being regarded as a packet of a new session.

As a method of attaining the switching of appliances without disconnecting sessions, a method may be used which is disclosed in Japanese Patent Application Publication No. P2004-229130 A (patent literature 1). In this method, an assignment control unit determines whether sessions are existing sessions which use appliances. The assignment control unit then assigns only new sessions to different appliances while keeping the existing, sessions. This effectively avoids disconnection of a session without handing over session information to an appliance to which the session is reassigned.

Also, Japanese Patent Application Publication No. P2004-274552 A (patent literature 2) discloses a method of transferring session information to another apparatus in accordance with the necessity. In this method, when the appliances are switched, a session is kept by transferring session information to an appliance to which the session is reassigned.

Furthermore, the following techniques are known in the art:

Japanese Patent Application Publication No. P2006-287605 A (patent literature 3) discloses a load balancer that can maintain an access to a server when a trouble occurs. The load balancer includes a first communication means, a second communication means, a load distribution means and a shortcut means. The first communication means communicates with a first network to which a plurality of servers are connected. The second communication means communicates with a second network which is operated in accordance with the same protocol as the first network and to which a client is connected. The load distribution means selects one of the plurality of servers to which data transmitted from the second communication means to the first communication means are to be supplied, on the basis of the load quantities of the plurality of servers, and transfers the data to the selected server. The shortcut means provides a shortcut between the first communication means and the second communication means and connects the first network and the second network not through the load distribution means.

Japanese Patent Application Publication No. P2007-156569 A (patent literature 4) discloses a cluster system for carrying out data communications through a plurality of load balancers. Even when a node server is not normally operated, the load balancers distribute messages belonging to the same session or plurality of related sessions, to the same cluster node. Consequently, the messages from the load balancers can be efficiently processed.

Japanese Patent Application Publication No. P2007-272472 A (patent literature 5) discloses a technique which eliminates the need of a re-login from a client terminal when servers are switched.

### SUMMARY OF INVENTION

The inventor remarks the following aspect. When an original appliance is stopped and its function is reassigned to a different appliance to switch appliances to be used, this causes the following problems:

The method disclosed in patent literature 1 requires waiting for the completion of all the sessions in order not to disconnect a session using an appliance after the original appliance is stopped. Thus, when there are many clients which use continuous connections, the original appliance cannot be stopped for a long time.

In addition, an appliance cannot detect the completion of a session with regard to a client which does not explicitly carry out a disconnecting process. An approach for addressing this may be to acknowledge completion of a session on basis of a non-communication state for a certain period and to disconnect the session. However, the period of the non-communication state is different depending on applications, and thus the uniform judgment based on timeout cannot always protect sessions from being disconnected.

According to the method disclosed in the patent literature 2, on the other hand, session information can be handed over to the appliance to which the session is reassigned. This requires, however, installation of a mechanism for receiving the session information from the original appliance and merging with the session information to its own session information onto the appliance to which the session is to be reassigned. Such mechanism cannot be used in many cases in a situation in which appliance models of a plurality of venders are simultaneously used.

An objective of the present invention is to provide a technique for efficiently switching appliances, while preventing an existing session from being disconnected.

In one aspect of the present invention, a network system is provided. The network system includes: a plurality of appliances provided in a network, one of the appliances being selected as an active appliance; a switch provided in the network; and a controller connected to the appliances and the switch. The switch contains a flow table, and entries in the flow table each specify an action to be performed on a packet matching with a matching condition. Upon receiving a packet, the switch refers to the flow table and performs the action specified by matching one of the entries which matches the received packet, on the received packet.

Let us consider a case when a first appliance of the appliances performs a first packet process on a packet belonging to an existing flow as the active appliance. When the active appliance is switched from the first appliance to a second appliance of the appliances, the controller performs a switching process after performing a shortcut process. In the shortcut process, the controller instructs the switch to set a first entry into the flow table. The first entry specifies that the first packet process is to be performed on a packet belonging to the existing flow. In the switching process, the controller instructs the switch to set a second entry into the flow table. The second entry specifies that a packet which is addressed to the active appliance and belongs to a new flow other than the existing flow is to be transferred to the second appliance.

In another aspect of the present invention, a controller is provided which is to be connected to appliances and a switch which are provided in a network. The switch contains a flow table, and the entries thereof each specify an action to be performed on a packet matching with a matching condition. Upon receiving a packet, the switch refers to the flow table and performs the action specified by matching one of the entries which matches the received packet, on the received packet.

Let us consider a case when a first appliance of the appliances is performing a first packet process on a packet belonging to an existing flow as an active appliance. When the active appliance is switched from the first appliance to a second appliance of the appliances, a processing unit of the controller performs a switching process after performing a shortcut process. In the shortcut process, the processing unit instructs the switch to set a first entry into the flow table. The first entry specifies that the first packet process is to be performed on a packet belonging to the existing flow. In the switching process, the processing unit instructs the switch to set a second entry into the flow table. The second entry specifies that a packet which is addressed to the active appliance and belongs to a new flow other than the existing flow is to be transferred to the second appliance.

In still another aspect of the present invention, a control method of a network in which appliances and a switch are provided. The switch contains a flow table, and entries of the flow table each specify an action to be performed on a packet matching with a matching condition. Upon receiving a packet, the switch refers to the flow table and performs the action specified by matching one of the entries which matches the received packet, on the received packet.

Let us consider a case when a first appliance of the appliances performs a first packet process on a packet belonging to an existing flow as an active appliance. The control method according to the present invention includes: switching the active appliance from the first appliance to a second appliance of the appliances. The switching includes: performing a shortcut process; and performing a switching process after the shortcut process. The shortcut process involves setting a first entry into the flow table in the switch. The first entry specifies that the first packet process is to be performed on a packet belonging to the existing flow. The switching process involves setting a second entry into the flow table in the switch. The second entry specifies that a packet which is addressed to the active appliance and belongs to a new flow other than the existing flow is to be transferred to the second appliance.

In still another aspect of the present invention, a non-transitory recording medium recording a control program which when executed causes a computer to perform a control process of a network in which appliances and a switch are provided. The switch contains a flow table, and entries of the flow table each specify an action to be performed on a packet matching with a matching condition. Upon receiving a packet, said switch refers to said flow table and performs said action specified by matching one of said entries which matches said received packet, on said received packet.

Let us consider a case when a first appliance of the appliances performs a first packet process on a packet belonging to an existing flow, as an active appliance. The control process includes: switching the active appliance from the first appliance to a second appliance of the appliances. The switching includes: performing a shortcut process; and performing a switching process after the shortcut process. The shortcut process involves setting a first entry into the flow table in the switch. The first entry specifies that the first packet process is to be performed on a packet belonging to the existing flow. The switching process involves setting a second entry into the flow table in the switch. The second entry specifies that a packet which is addressed to the active appliance and belongs to a new flow other than the existing flow is to be transferred to the second appliance.

The present invention efficiently attains switching of appliances, while preventing an existing, flow from being disconnected.

### BRIEF DESCRIPTION OF THE DRAWINGS

The above and other objects, advantages and features would be apparent from embodiments of the present invention described together with the following drawings:

FIG. 1 is a block diagram schematically showing the configuration of a network system according to one embodiment of the present invention;

FIG. 2 is a block diagram showing the functional configuration according to this embodiment;

FIG. 3 is a conceptual view showing a flow table provided in a switch according to this embodiment;

FIG. 4 is a block diagram showing the configuration of a controller according to this embodiment;

FIG. 5 is a block diagram showing a process according to this embodiment;

FIG. 6 is a flowchart showing the process according to this embodiment;

FIG. 7 is a block diagram showing a collection process according to this embodiment;

FIG. 8 is a block diagram showing a shortcut process according to this embodiment;

FIG. 9 is a block diagram showing a switching process according to this embodiment;

FIG. 10 is a flowchart showing a temporal packet process according to this embodiment;

FIG. 11 is a block diagram showing an exemplary configuration of a network system for presenting a specific example of the process according to this embodiment;

FIG. 12 shows the initial state of a flow table in the specific example;

FIG. 13 shows the flow table obtained as the result of the collection process in this specific example;

FIG. 14 shows the flow table obtained as the result of the shortcut process in this specific example;

FIG. 15 shows the flow table obtained as the result of the shortcut process in this specific example; and

FIG. 16 shows the flow table obtained as the result of the switching process in this specific example.

### DESCRIPTION OF PREFERRED EMBODIMENTS

The embodiment of the present invention will be described below with reference to the attached drawings.

### 1. Configuration

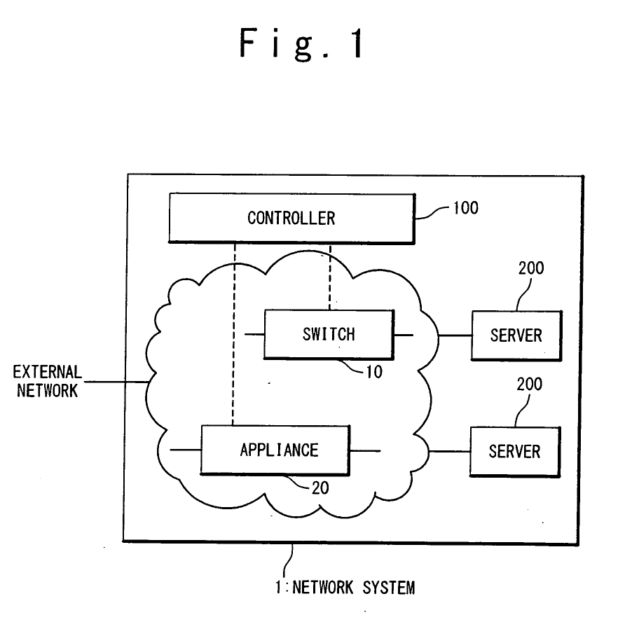

FIG. 1 is the block diagram schematically showing the configuration of a network system 1 according to an embodiment. The network system 1 according to this embodiment may be applied to, for example, a data center.

The network system 1 includes switches 10 (one shown), appliances 20 (one shown), a controller 100 and servers 200. The switches 10 and the appliances 20 configure a switch-appliance network. The servers 200 are connected to the switch-appliance network. The switch-appliance network is further connected to an external network outside the network system 1. The controller 100 is connected to the switches 10 and the appliances 20 through control lines (shown by dashed lines in FIG. 1).

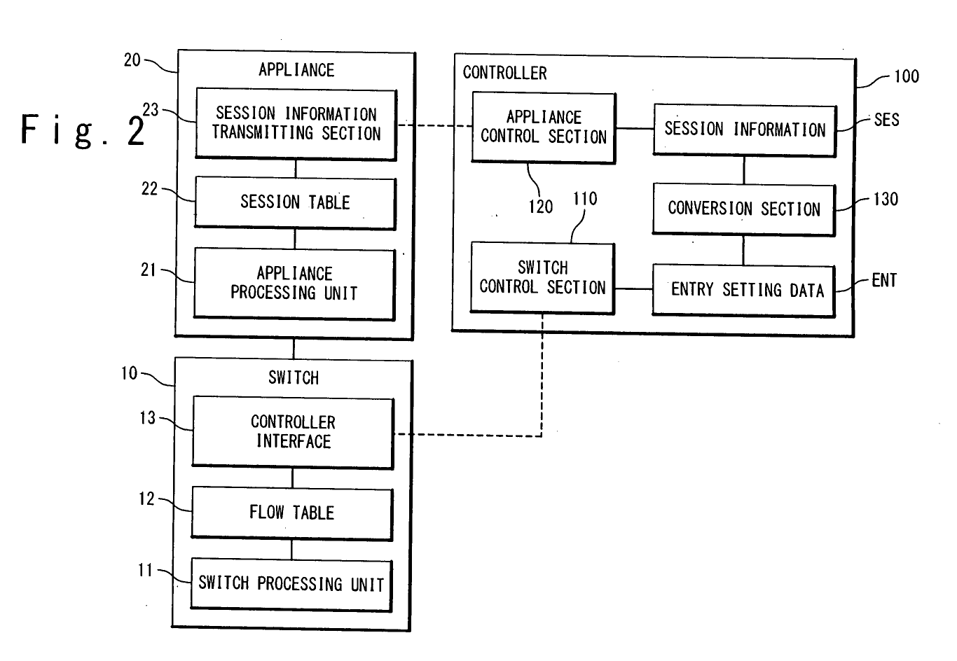

FIG. 2 shows the respective functional configurations of the switches 10, the appliances 20 and the controller 100 according to this embodiment. Each configuration of the switches 10, the appliances 20 and the controller 100 will be described below in detail.

### 1-1. Switch 10

The switches 10 each carry out a switching process such as a packet transfer and the like. In detail, as shown in FIG. 2, the switches 10 each contain a switch processing unit 11, a flow table 12 and a controller interface 13.

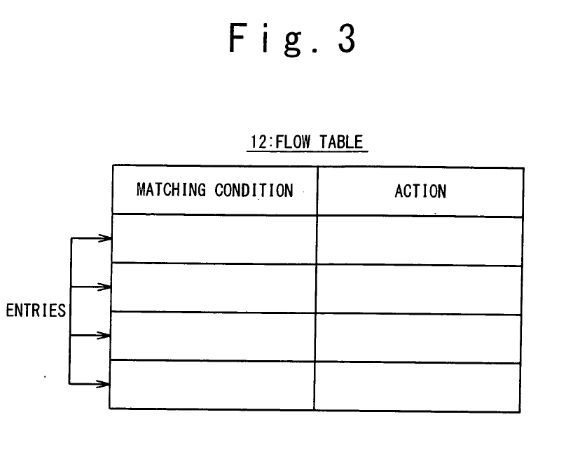

FIG. 3 conceptually shows the flow table 12. Each of entries on the flow table 12 indicates a “matching condition (flow identification information)” and an “action”. The “matching condition” is composed of a combination of parameters, such as an input port of packets, a source MAC address, a destination MAC address, a source IP address, a destination IP address, a source port number, a destination port number and the like. It should be noted that a flow is defined by the combination of those parameters. In short, the “matching condition” is also flow identification information for defining the flow. The “action” means one or more processes that are to be performed on a packet matching the matching condition. Examples of the “action” include packet outputting to a specified port, rewriting of a particular field in a packet header, packet discarding and the like. It should be noted that the flow table 12 is stored in a storage device.

The switch processing unit 11 carries out a switching process in accordance with the flow table 12. In detail, the switch processing unit 11 receives packets through input ports. When receiving a packet, the switch processing unit 11 refers to the flow table 12 and retrieves the entry matching the received packet. Specifically, the switch processing unit 11 extracts header information of the received packet and searches the flow table 12, using the input port and header information of the received packet as a search key. The entry indicating the matching condition which matches the search key is defined as the matching entry for the received packet. When the received packet matches the matching condition of any entry, namely, when a matching entry is found out, the switch processing unit 11 performs the “action” specified by the matching entry on the received packet.

The controller interface 13 is connected through the control line to the controller 100 and serves as an interface for communicating with the controller 100. Also, the controller interface 13 has the function of setting the entries of the flow table (an addition, a change, a removal and the like) in response to instructions from the controller 100. Moreover, the controller interface 13 has the function of directly outputting a packet to a particular port, independently of the contents of the flow table 12 in response to instructions from the controller 100.

### 1-2. Appliance 20

The appliances (network appliances) 20 are each a network apparatus for performing a particular process on the network traffic. Examples of the appliances 20 include a load balancer and a firewall.

A load balancer provides the function of load distribution. In detail, a load balancer is acknowledged as a virtual server from the external network. A client specifies the virtual IP address (VIP) and the port number corresponding to this virtual server to issue a request. The load balancer selects one real server which actually provides a service to the client from a plurality of real servers which are previously associated with the virtual server. The load balancer then rewrites the destination address (for example, the MAC address or both of the MAC address and the IP address) in the request packet to that of the selected real server and transfers the request to the real server.

A firewall provides the function of ensuring the security through the communication control. In detail, a firewall passes or discards a packet on the basis of conditions such as the IP address, the port number or the like. Also, a control may be implemented in which only response packets for packets which have been passed are passed. In this way, the firewall manages the states of connections and sessions to strongly ensure the security.

As shown in FIG. 2, the appliance 20 includes an appliance processing unit 21, a session table 22 and a session information transmitting section 23.

The session table 22 indicates information with regard to flows (or sessions) which are being processed by the appliance 20 in which the session table 22 is provided. The information with regard to the flows may include the source IP addresses, the source port numbers, the destination IP addresses, the destination port numbers and the like, similarly to the above-described flow identification information. When the appliance 20 is a load balancer, for example, the session table 22 also indicates the real servers that actually process packets belonging to each flow.

The appliance processing unit 21 executes a particular process as the appliance 20. When the appliance 20 is a load balancer, for example, the appliance processing unit 21 extracts information of the destination virtual server (the virtual IP address and the port number) from the header of an input packet and selects one from the plurality of real servers associated with the virtual servers. Then, the appliance processing unit 21 rewrites information of the destination address included in the header of the packet to that of the selected real server and then transmits the packet. Also, the appliance processing unit 21 registers the selected real server into the session table 22, so as correlate the selected real server to the flow. From then on, the appliance processing unit 21 can perform the packet process on packets belonging to the same flow, by referring to the session table 22.

The session information transmitting section 23 is connected through a control line to the controller 100. This session information transmitting section 23 has the function of transmitting session information SES indicative of the contents of the session table 22 to the controller 100, in response to a request from the controller 100.

### 1-3. Controller 100

The controller 100 has the function of setting the contents of the flow table 12 in each switch 10 through the control line. Specifically, the controller 100 prepares entry setting data ENT to instruct to set an entry (addition, change, removal or the like) and sends the entry setting data ENT to a target switch 10. The controller interface 13 in the target switch 10 receiving the entry setting data ENT carries out the setting of the entry in its own flow table 12 in accordance with the entry setting data ENT. In this way, the controller 100 controls the operation of each switch 10 through the setting of the contents of the flow table 12, and thereby properly controls the network traffic.

An example of the interface protocol between the controller 100 and the switch 10 to attain the afore-mentioned includes Openflow (refer to http://www.openflowswitch,org/) for example. In this case, an “Openflow controller” serves as the controller 100, and “Openflow switches” serve as the switches 10.

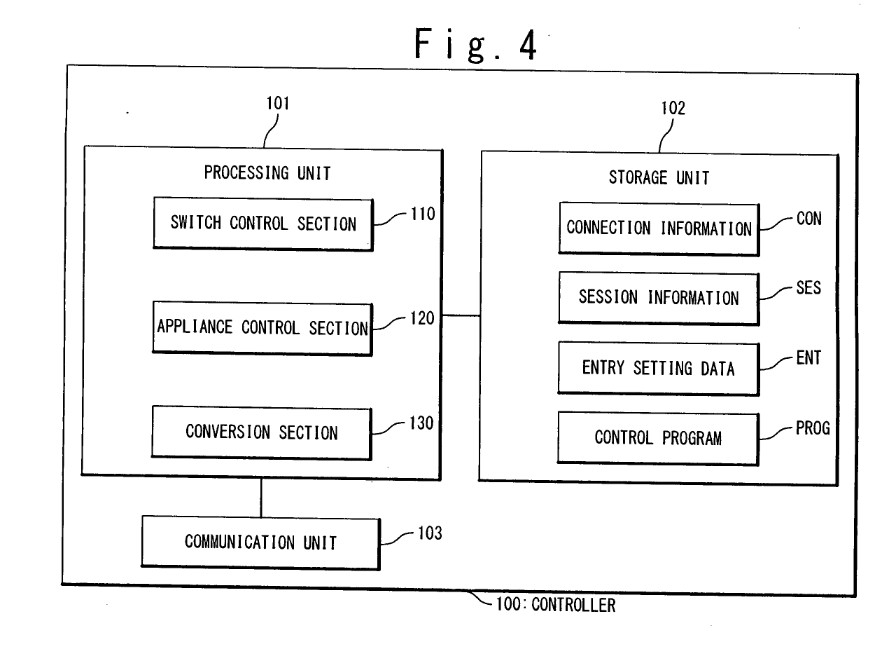

FIG. 4 is the block diagram showing the configuration of the controller 100 according to this embodiment. The controller 100 includes a processing unit 101, a storage unit 102 and a communication unit 103. The processing unit 101 may include a CPU (central processing unit). The storage unit 102 may include an RAM (Random Access Memory) and an HDD (Hard Disk Drive), for example. The communication unit 103 may include a network card for communicating with the exterior, for example.

The storage unit 102 stores connection information CON, session information SES, entry setting data ENT and the like.

The connection information CON indicates connections in the network. In short, the connection information CON indicates the connections (or topology) between the components, including the switches 10, the appliances 20 and the servers 200. In detail, the connection information CON indicates to which port of which component each port in each component is connected. Examples of the identification information of each of the components include, MAC addresses, IP addresses and the like.

The session information SES indicates the contents of the session tables 22 in the appliances 20. This session information SES can be obtained from the appliances 20. Details thereof will be described later.

The entry setting data ENT are the information that instructs target switches 10 to carry out the setting of the entries (the addition, the change, the removal or the like), as mentioned above.

The processing unit 101 carries out a “network control process” according to this embodiment. In detail, as shown in FIG. 4, the processing unit 101 contains a switch control section 110, an appliance control section 120 and a conversion section 130. Those functional blocks may be implemented by executing a control program PROG on the processing unit 101. The control program PROG is a computer program executed by the computer (processing unit 101) and stored in the storage unit 102. The control program PROG may be stored in a computer-readable recording medium.

The switch control section 110 is connected to the switches 10 through the control lines to communicate with the switches 10. This switch control section 110 has the function for instructing each switch 10 to set a desired entry into the flow table 12. Specifically, the switch control section 110 prepares entry setting data ENT for instructing to set a desirable entry and stores the entry setting data ENT in the storage unit 102. The entry setting data ENT may be prepared by the communication unit 103, as described later. The switch control section 110 reads the entry setting data ENT from the storage unit 102 and transmits the entry setting data ENT to each switch 10. Consequently, desired entries can be set for the flow table 12 in each switch 10.

The appliance control section 120 is connected through the control lines to the appliances 20 to communicate with the appliances 20. The appliance control section 120 has the function of acquiring the session information SES from the desirable appliance 20. In detail, the appliance control section 120 requests a desired appliance 20 to transmit session information SES. In response to the request, the session information transmitting section 23 in the relevant appliance 20 transmits the session information SES which indicates the contents of its own session table 22 to the controller 100. The appliance control section 120 receives the session information SES from the relevant appliance 20 and stores the session information SES in the storage unit 102.

The conversion section 130 has the function of converting session information SES into entry setting data ENT. As mentioned above, the appliances 20 each perform the predetermined packet process on packets belonging to a certain flow, by referring to the session table 22. If the contents of the session table 22 can be reflected in the flow table 12 in a switch 10, the switch 10 would be able to perform the same packet process on the packets belonging to the same flow. That is, the predetermined packet process, which is to be performed on the received packet by the appliance 20, can be handed over to the switch 10. In order to achieve this, the conversion section 130 reads the session information SES from the storage unit 102 and prepares the entry setting data ENT based on the session information SES. The prepared entry setting data ENT instructs the switch 10 to set an entry for attaining the same packet process as the appliance 20. The conversion section 130 stores the prepared entry setting data ENT in the storage unit 102.

### 2. Process Flow

A network control process according to this embodiment will be described below in detail.

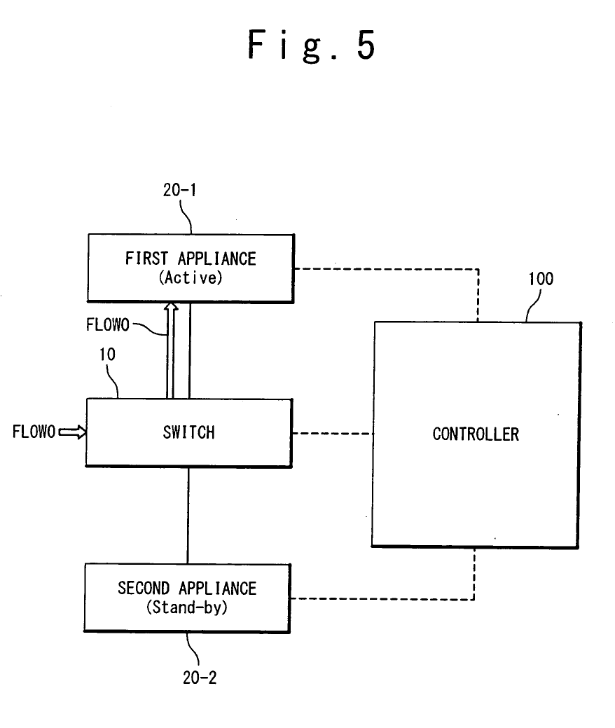

As an example, let us consider a state shown in FIG. 5. In FIG. 5, a first appliance 20-1 is an active appliance 20, and a second appliance 20-2 is in a standby state. The flow table 12 in a switch 10 includes an entry which specifies that packets addressed to the appliance 20 are to be transferred to the first appliance 20-1: A flow FLOW0 is an existing flow currently processed by the appliance 20, and the destination of packets belonging to the existing flow FLOW0 is the appliance 20. When receiving a packet belonging to the existing flow FLOW0, the switch 10 transfers the received packet to the first appliance 20-1 in accordance with the matching entry in the flow table 12. The first appliance 20-1 receives the packet belonging to the existing flow FLOW0 and performs a predetermined packet process (a process as the load balancer, the process as the firewall or the like) on the received packet in accordance with the session table 22.

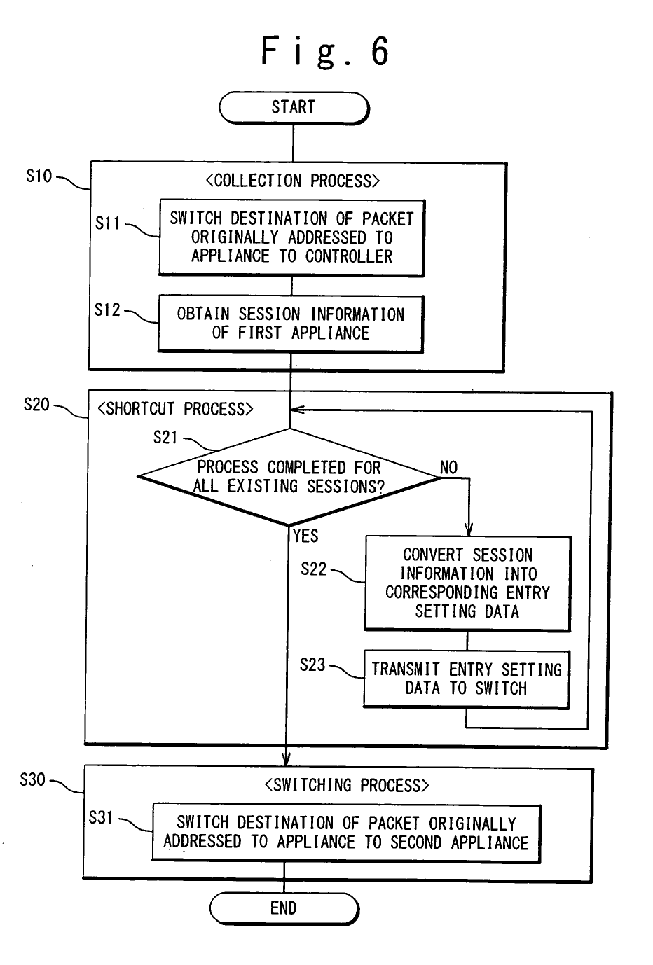

Here, let us consider that the appliance 20 to be used is switched from the first appliance 20-1 to the second appliance 20-2. In short, let us consider that the first appliance 20-1 is to be stopped for maintenance and the like and the function is handed over to the other second appliance 20-2. FIG. 6 is the flowchart showing the process in that case.

### 2-1. Collection Process (Step S10)

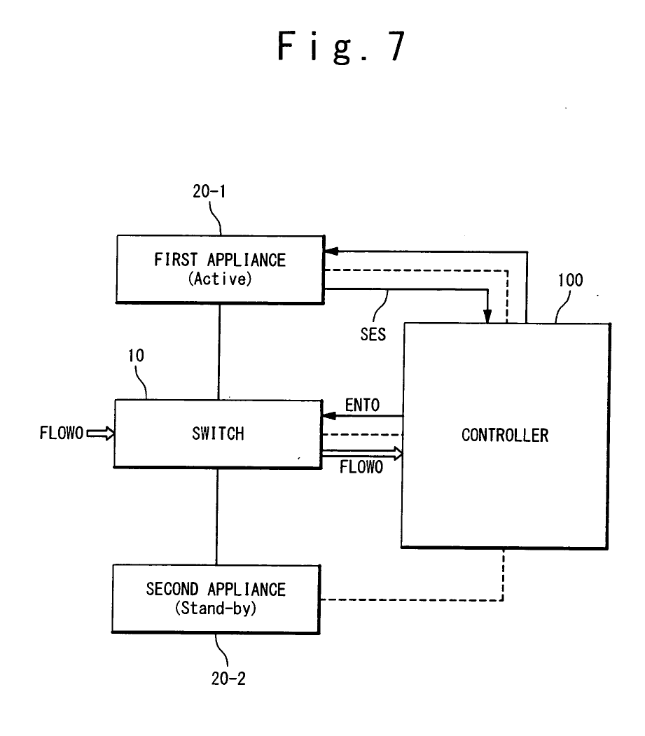

At first, the controller 100 carries out a “collection process” (Step S10). A description is given below of the collection process with reference to FIG. 7 and FIG. 2.

### Step S11:

The controller 100 carries out a process for collecting packets originally addressed to the appliance 20 to the controller 100, not to the first appliance 20-1. In order to do so, the switch control section 110 in the controller 100 prepares entry setting data ENT0 for instructing to set a “transfer entry”. The transfer entry specifies that “packets addressed to the appliance 20 are to be transferred to the controller 100”. The switch control section 110 transmits the entry setting data ENT0 to the switch 10. That is, the switch control section 110 instructs the switch 10 to set the transfer entry into the flow table 12.

The controller interface 13 in the switch 10 receives the entry setting data ENT0 from the controller 100. The controller interface 13 sets the transfer entry into the flow table 12, in accordance with the entry setting data ENT0. When then receiving packets addressed to the appliance 20, the switch processing unit 11 transfers the received packets to the controller 100 in accordance with the transfer entry. The packets that at least belong to the existing flow FLOW0 are consequently transferred to the controller 100, not to the first appliance 20-1. The process performed on the packets by the controller 100 will be described later (refer to section 2-4).

### Step S12:

Also, the controller 100 acquires the session information SES from the first appliance 20-1 of the original entity. In detail, the appliance control section 120 in the controller 100 requests the first appliance 20-1 to transmit the session information SES. In response to the request, the session information transmitting section 23 in the first appliance 20-1 transmits the session information SES, which indicates the contents of its own session table 22, to the controller 100. The appliance control section 120 receives the session information SES from the first appliance 20-1. The session information SES includes information with regard to the packet process which is to be performed on the packets belonging to the existing flow FLOW0 by the first appliance 20-1, which is the original entity performing the packet process.

### 2-2. Shortcut Process (Step S20)

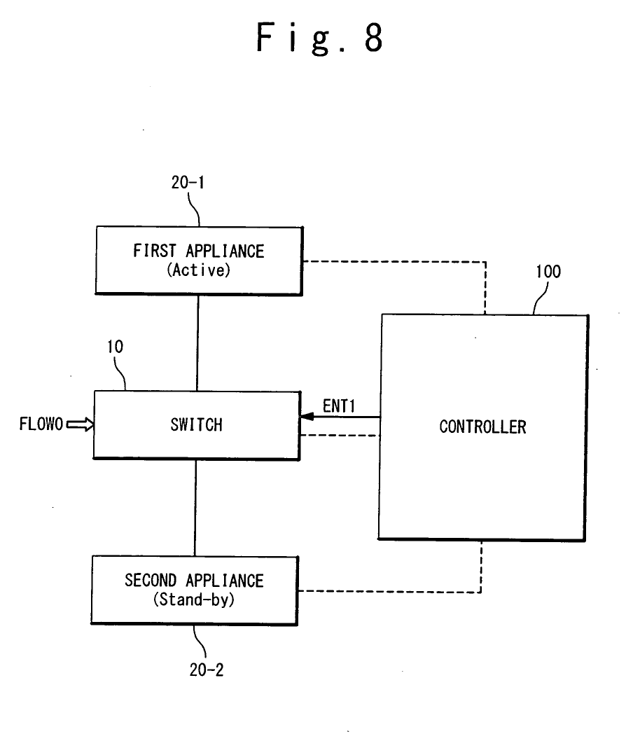

Next, the controller 100 carries out a “shortcut process” (Step S20). The shortcut process means that the predetermined packet process which is originally performed on packets by the appliance 20 is handed over to the switch 10. In short, the shortcut process involves that causing the switch 10 to carry out the same packet process as the appliance 20, without using the appliance 20. A description is given below of the shortcut process below with reference to FIG. 8 and FIG. 2.

### Step S21:

The shortcut process is performed on each of the existing flows (existing sessions) which are being handled by the first appliance 20-1, which is the original entity handling the existing flows. Here, a shortcut process with regard to the above-mentioned existing flow FLOW0 is described as a representation. The controller 100 performs the following processes on the existing flow FLOW0 (Steps S22, S23).

### Step S22:

The conversion section 130 in the controller 100 prepares first entry setting data ENT1, which instructs to set a “first entry” in accordance with the session information SES acquired at step S12 as mentioned above. The first entry instructs “to perform the same packet process as the first appliance 20-1 on packets belonging to the existing flow FLOW0”. The flow identification information of the existing flow FLOW0 is known from the session information SES. Also, the packet process, which is to be performed on packets belonging to the existing flow FLOW0 by the first appliance 20-1, is known from the session information SES. When a packet transfer is required as the packet process (the action specified in the entry), an output port is known by referring to the connection information CON. That is, the conversion section 130 can prepare the first entry setting data ENT1 in accordance with the session information SES, by referring to the session information SES and the connection information CON.

### Step S23:

The switch control section 110 in the controller 100 transmits the prepared first entry setting data ENT1 to the switch 10. That is, the switch control section 110 instructs the switch 10 to set the first entry into the flow table 12.

The controller interface 13 in the switch 10 receives the first entry setting data ENT1 from the controller 100. The controller interface 13 sets the first entry into the flow table 12 in accordance with the first entry setting data ENT1. When then receiving a packet belonging to the existing flow FLOW0, the switch processing unit 11 performs the same packet process as the first appliance 20-1 on the received packet in accordance with the first entry. That is, packets belonging to the existing flow FLOW0 are anymore processed without using the first appliance 20-1.

### 2-3. Switching Process (Step S30)

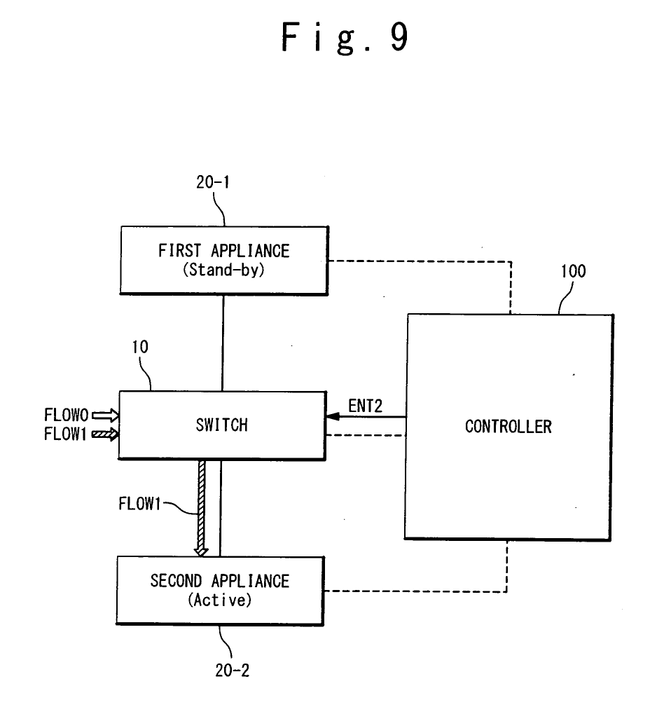

Next, the controller 100 carries out a “switching process” (Step S30). A description is given below of the switching process with reference to FIGS. 9 and 2. At this timing, the active appliance 20 is switched to the second appliance 20-2.

### Step S31:

The controller 100 carries out a process for switching new flows addressed to the appliance 20 to the second appliance 20-2, which is the destination entity to which the new flows are handed over. In order to do so, the switch control section 110 in the controller 100 prepares second entry setting data ENT2 for instructing to set a “second entry”. The second entry specifies that “packets addressed to the appliance 20 (packets belonging to a new flow other than the existing flow FLOW0) are to be transferred to the second appliance 20-2”. The switch control section 110 transmits the second entry setting data ENT2 to the switch 10. That is, the switch control section 110 instructs the switch 10 to set the second entry into the flow table 12.

The controller interface 13 in the switch 10 receives the second entry setting data ENT2 from the controller 100. The controller interface 13 sets the second entry into the flow table 12 in accordance with the second entry setting data ENT2. When then receiving packets addressed to the appliance 20 belonging to a new flow FLOW1, the switch processing unit 11 transfers the received packet to the second appliance 20-2 in accordance with the second entry. In short, packets belonging to the new flow FLOW1 other than the existing flow FLOW0 are transferred to the second appliance 20-2, which is the destination entity.

### 2-4. Temporal Packet Process

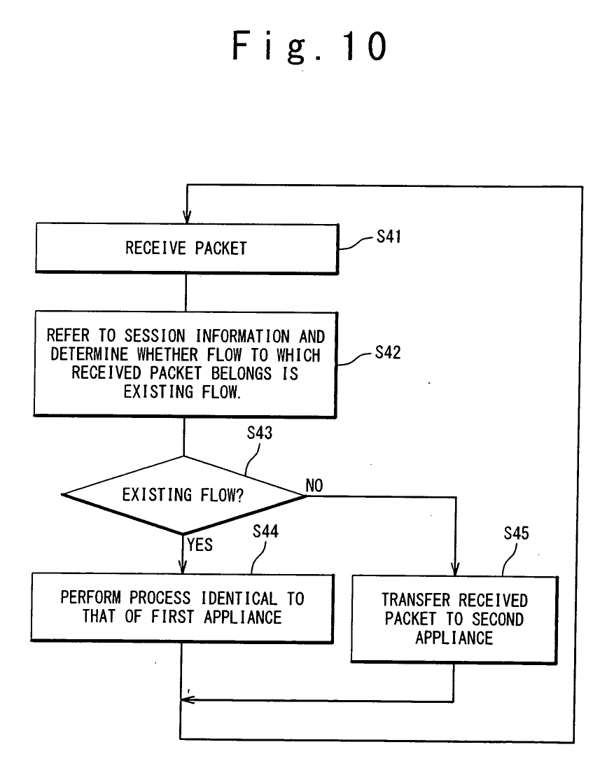

As the result of step S11, packets addressed to the appliance 20 are transferred to the controller 100, for a while. The controller 100 performs a “temporal packet process” on the transferred packets. This temporal packet process is performed in parallel to steps S10 to S30. The temporal packet process will be described below with reference to FIG. 10.

The switch control section 110 in the controller 100 receives a transferred packet from the switch 10 (Step S41). The switch control section 110′ determines whether the transferred packet belongs to the existing flow based on the header information of the transferred packet and the session information SES (Step S42).

When the transferred packet belongs to the existing flow (Step S43; Yes), the same packet process as the first appliance 20-1 is performed (Step S44). Specifically, the switch control section 110 returns the transfer packet to the switch 10 and further instructs the switch 10 to “perform the same packet process as the first appliance 20-1 on the transfer packet”. The controller interface 13 in the switch 10 performs the same packet process as the first appliance 20-1 on the transfer packet in accordance with the instructions from the controller 100. Instead, the switch control section 110 may return the transfer packet to the switch 10 after the completion of step S23.

When the transfer packet belongs to a new flow (Step S43; No), on the other hand, the packet is transferred to the second appliance 20-2 (Step S45). Specifically, the switch control section 110 returns the transfer packet to the switch 10 and further instructs the switch 10 to “transfer the transfer packet to the second appliance 20-2”. The controller interface 13 in the switch 10 outputs the transfer packet to the second appliance 20-2 in accordance with the instruction from the controller 100.

It should be noted that the switch control section 110 may firstly check an SYN flag of the transfer packet at step S42. If the SYN flag is set, this implies a new session. Thus, in that case, the switch control section 110 can immediately execute step S45. This contributes reduction in the processing time. Also, an entry may be additionally set, which instructs to transfer the packet of the new flow transferred at step S45 to the second appliance. This effectively prevents a subsequent packet which belongs to a flow once processed as a new flow from being transferred to the controller 100 again. This contributes the reduction in the processing time of the controller 100 and the decrease in the load.

### 2-5. Advantageous Effect

As mentioned above, the shortcut process (Step S20) is carried out in this embodiment. Consequently, the predetermined packet process which is originally being performed by the first appliance 20-1, which is the original entity, can be handed over to the switch 10 so that the existing flow (existing session) is maintained. When the shortcut process is then completed (Step S20), there is no existing flow which passes through the first appliance 20-1. Thus, the first appliance 20-1 can be disconnected from the network at that time. That is, it is not necessary to wait for the completion of all the sessions using the first appliance 20-1, and it is not necessary to set the timeout of an indefinite period. The operation of the first appliance 20-1 can be stopped in a predictable time without any disconnection of the existing flow.

Also, the second appliance 20-2, which is the destination entity, is not required to have a mechanism for receiving the session information SES from the first appliance 20-1, which is the original entity. Thus, even when the venders of the first appliance 20-1 and the second appliance 20-2 are different, the present invention can be easily implemented.

Moreover, when only one appliance 20 exists on the network, the shortcut process enables the existing session to be kept in its original state, although no new session can be used.

### 3. Specific Example

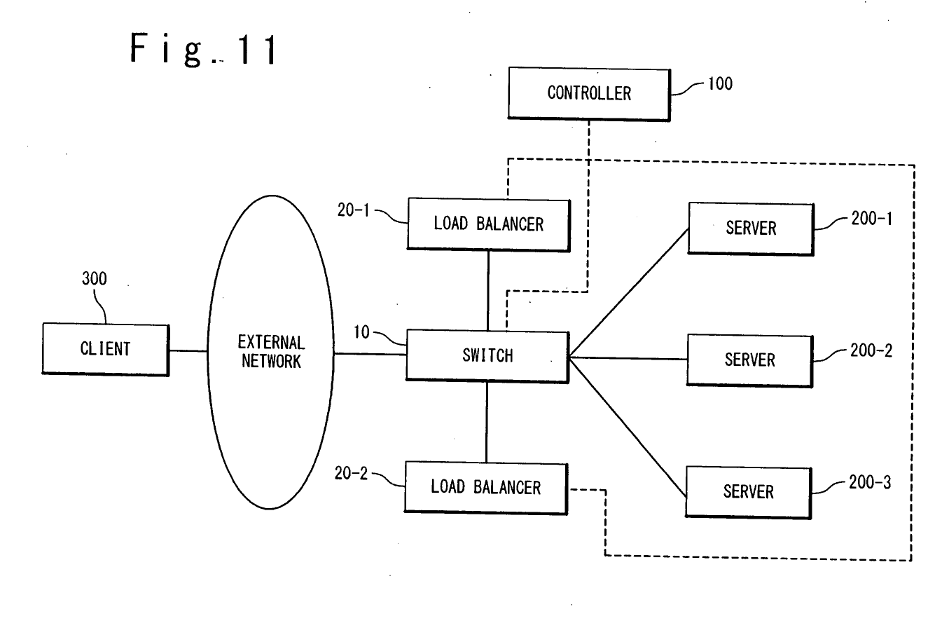

A specific example of the appliance switching process according to this embodiment will be described below. Here, the network configuration shown in FIG. 11 is considered.

In FIG. 11, load balancers 20-1, 20-2 as appliances 20 and servers 200-1 to 200-3 as real servers are connected to a switch 10. The load balancer 20-1 is in the active state, and the load balancer 20-2 is in the standby state. In the load balancer 20, a virtual IP address VIP1 corresponding to a virtual server is serviced at a TCP port 80. The real server group corresponding to the virtual IP address VIP1 includes the servers 200-1 to 200-3. The IP addresses of the servers 200-1, 200-2 and 200-3 are IP1, IP2 and IP3, respectively, and the MAC addresses thereof are MAC1, MAC2 and MAC3, respectively. Also, the service port of each server 200 is the TCP port 80 as is the case of the virtual server. A client 300 accesses the real servers 200 through the virtual server provided by the load balancer 20 from the external network.

It is possible to reach a router, which is connected to the external network, from the load balancer 20 by using a MAC address EXT. Also, the real server group 200 specifies the load balancer 20 as a default gateway in order to process a return packet, and its IP address is LB. The load balancers 20-1 and 20-2 have MAC addresses LB1 and LB2, respectively.

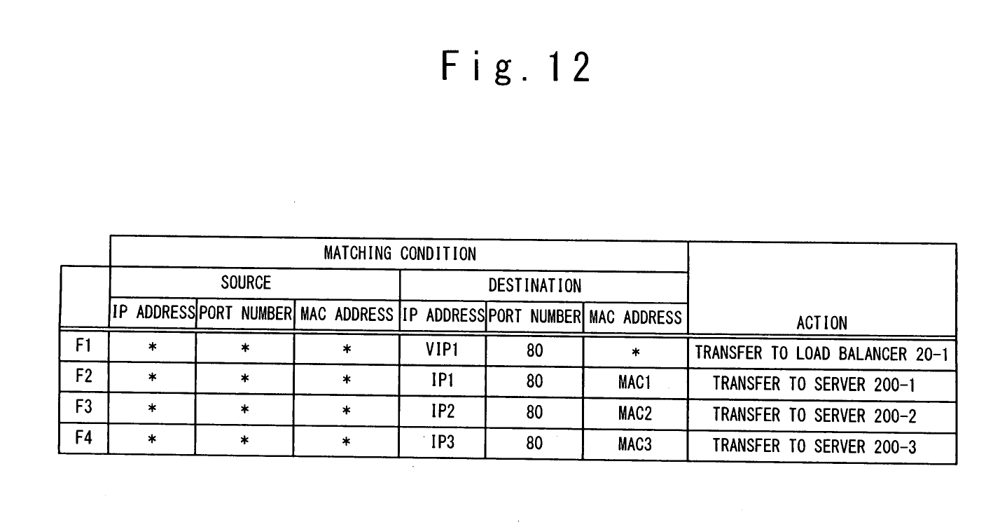

FIG. 12 shows the state of the flow table 12 of the switch 10. The asterisks (*) in the flow table 12 represent arbitrary values. An entry F1 specifies that “packets addressed to the load balancer 20 (VIP1) are to be transferred to the load balancer 20-1”. An entry F2 specifies that “packets addressed to the server 200-1 (IP1, MAC1) are to be transferred to the server 200-1”. An entry F3 specifies that “packets addressed to the server 200-2 (IP2, MAC2) are to be transferred to the server 200-2”. An entry F4 specifies that “packets addressed to the server 200-3 (IF3, MAC3) are to be transferred to the server 200-3”.

The client 300 issues a TCP connection request to the load balancer 20. The destination IP address of packets transmitted by the client 300 is set to VIP1. When receiving the packets, the switch 10 refers to the flow table 12 shown in FIG. 12. At this time, the entry F1 is the hit entry and thus the switch 10 transfers the received packets to the load balancer 20-1.

The load balancer 20-1 receives the packets and selects, for example, the server 200-1 as the real server which should process the flow. The load balancer 20-1 performs the packet process on the received packets. Specifically, the load balancer 20-1 rewrites the destination IP address to IP1, rewrites the destination MAC address to MAC1 and then transmits the packets to the server 200-1. When receiving the packets, the switch 10 refers to the flow table 12 shown in FIG. 12. At this time, the switch 10 transfers the received packets to the server 200-1, since the entry F2 is the hit entry.

As for response packets to the client 300 from the server 200-1, the destination IP address and the destination port number are determined to specify the client 300, and the destination MAC address is LB1. The load balancer 20-1 rewrites the source IP address to VIP1, rewrites the destination MAC address to EXT and then transfers the response packets to the external network. The client 300 receives these packets.

In this state, let us consider that the active load balancer 20 is switched from the load balancer 20-1 to the load balancer 20-2.

### Step S11:

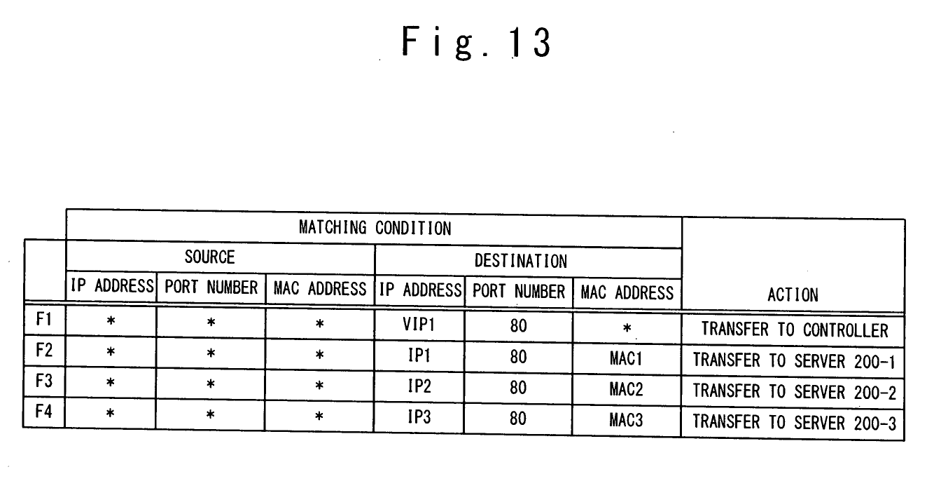

The controller 100 transmits the entry setting data ENT0 which instructs to set the “transfer entry” into the switch 10. As a result, as shown in FIG. 13, the entry F1 is rewritten to specify that “packets addressed to the load balancer 20 (VIP1) are to be transferred to the controller 100”. The controller 100 temporally receives packets addressed to the load balancer 20 and carries out the temporal packet process.

### Step S12:

Also, the controller 100 acquires the session information SES from the load balancer 20-1, which is the original entity. The session information SES includes information with regard to the packet process which is to be performed on received packets by the load balancer 20-1.

### Step S20:

The controller 100 prepares first entry setting data ENT1 which instructs to set a “first entry” in accordance with the session information SES. The first entry specifies that “the same packet process as the load balancer 20-1 is to be performed on packets belonging to an existing flow”. The controller 100 transmits the first entry setting data ENT1 to the switch 10. The switch 10 sets the first entry into the flow table 12 in accordance with the first entry setting data ENT1.

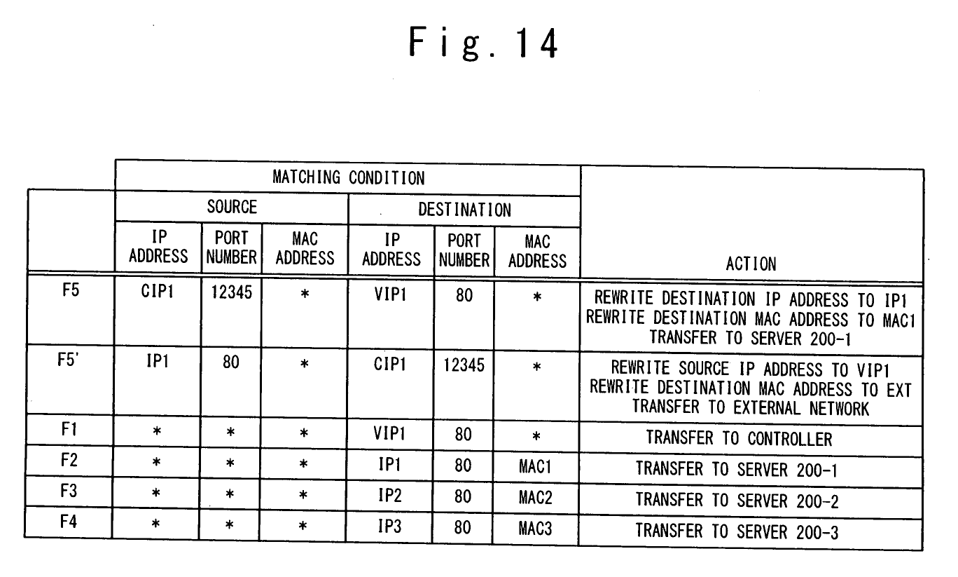

FIG. 14 shows the flow table 12 for which a “first entry F5” is set with regard to a certain one existing flow (a client IP address=CIP1, a port number=12345, a destination IP address=VIP1 and a destination port number=80). The first entry F5 specifies that “for packets belonging to the existing flow, the destination IP address is rewritten to IP1, and the destination MAC address is rewritten to MAC1, and the packets are to be transferred to the real server 200-1”. This first entry F5 is set into the flow table 12 at a priority higher than that of the entry F1. As a result, packets belonging to the existing flow are directly transmitted to the real server 200-1 not through the load balancer 20-1. It should be noted that an entry F5′ is intended to attain the shortcut of the return traffic to the client 300 from the real server 200-1. This entry F5′ is also set similarly to the first entry F5.

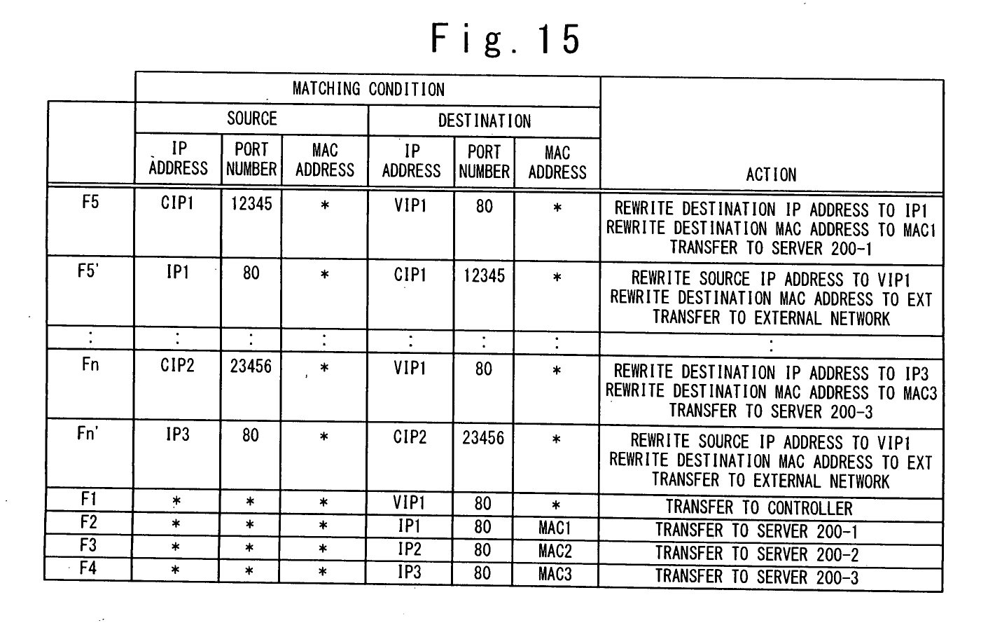

FIG. 15 shows a case that the first entries F5 to Fn and F5′ to Fn′ are set for a plurality of different existing flows, respectively. Each of the first entries F5 to Fn and F5′ to Fn′ is set similarly to the case of FIG. 14.

### Step S30:

The controller 100 prepares second entry setting data ENT2 that instruct to set a “second entry”. The second entry specifies that “packets addressed to the load balancer 20 (packets belonging to a new flow other than the existing flow) are to be transferred to the load balancer 20-2”. The controller 100 transmits the second entry setting data ENT2 to the switch 10. The switch 10 sets the second entry into the flow table 12 in accordance with the second entry setting data ENT2.

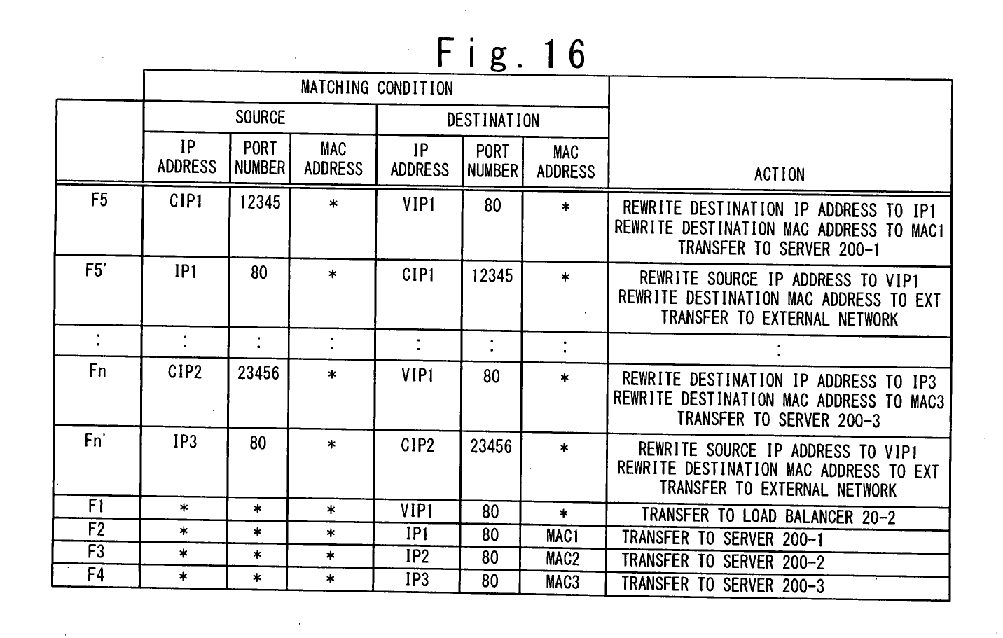

In this example, as shown in FIG. 16, the entry F1 is rewritten to specify that “packets addressed to the load balancer 20 (VIP1) are to be transferred to the load balancer 20-2”. As a result, packets belonging to the existing flows are processed without using the load balancer 20-1 in accordance with the first entries F5 to Fn and F5′ to Fn'. On the other hand, packets belonging to a new flow other than the existing flows are transferred to the load balancer 20-2 in accordance with the entry F1.

As thus described, it is possible to switch the active load balancer 20 in a short time, without disconnecting the existing flows. The same goes for the firewall.

It should be noted that, when the active load balancer is switched to the load balancer 20-2, the IP address (VIP1 and LB) of the load balancer 20-1 is handed over to the load balancer 20-2. The fact that the MAC address corresponding to this IP address is changed from LB1 to LB2 is also reported to the server 200 through a mechanism of the ARP (Address Resolution Protocol).

Although embodiments of the present invention have been described by referring to the attached drawings, the present invention is not limited to the above-mentioned embodiments; the present invention may be changed by the person skilled in the art without departing from the scope.

This application claims the priority based on Japan Patent Application No. 2010-020391, filed on Feb. 1, 2010 and the entire disclosure of which is incorporated herein by reference.

What is claimed is:

1. A network system, comprising:
a plurality of appliances provided in a network, one of said appliances being selected as an active appliance;
a switch provided in said network; and
a controller connected to said appliances and said switch,
wherein said switch contains a flow table, wherein entries in said flow table each specify an action to be performed on a packet matching with a matching condition,
wherein, upon receiving a packet, said switch refers to said flow table and performs said action specified by matching one of said entries which matches said received packet, on said received packet, wherein a first appliance of said appliances performs a first packet process on a packet belonging to an existing flow, when said first appliance is selected as said active appliance, and
wherein, when said active appliance is switched from said first appliance to a second appliance of said appliances, said controller performs a switching process after performing a shortcut process, and
wherein, in said shortcut process, said controller instructs said switch to set a first entry into said flow table, said first entry specifying that said first packet process is to be performed on a packet belonging to said existing flow, and
wherein, in said switching process, said controller instructs said switch to set a second entry into said flow table, said second entry specifying that a packet which is addressed to said active appliance and belongs to a new flow other than said existing flow is to be transferred to said second appliance.

2. The network system according to claim 1, wherein said first appliance performs said first packet process on the packet belonging to said existing flow, by referring to a session table that indicates information with regard to a flow to be processed by said first appliance,
wherein said controller acquires session information indicating contents of said session table of said first appliance, and
wherein said controller instructs said switch to set said first entry into said flow table based on said session information.

3. The network system according to claim 2, wherein said controller instructs said switch to set a transfer entry into said flow table before said shortcut process, said transfer entry specifying that a packet addressed to said active appliance is to be transferred to said controller.

4. The network system according to claim 3, wherein, upon receiving a transfer packet from said switch, said controller determines based on header information of said transfer packet and said session information whether said transfer packet belongs to said existing flow, and returns said transfer packet to said switch,
wherein, when said transfer packet belongs to said existing flow, said controller instructs said switch to perform said first packet process on said transfer packet, and
wherein, when said transfer packet does not belong to said existing flow, said controller instructs said switch to transfer said transfer packet to said second appliance.

5. A controller to be connected to appliances and a switch which are provided in a network, wherein said switch contains a flow table, entries of which each specify an action to be performed on a packet matching with a matching condition, wherein, upon receiving a packet, said switch refers to said flow table and performs said action specified by matching one of said entries which matches said received packet, on said received packet, and wherein a first appliance of said appliances performing a first packet process on a packet belonging to an existing flow, when said first appliance is selected as said active appliance,
said controller comprising: a processing unit,
wherein, when said active appliance is switched from said first appliance to a second appliance of said appliances, said processing unit performs a switching process after performing a shortcut process, and
wherein, in said shortcut process, said processing unit instructs said switch to set a first entry into said flow table, said first entry specifying that said first packet process is to be performed on a packet belonging to said existing flow, and
wherein, in said switching process, said processing unit instructs said switch to set a second entry into said flow table, said second entry specifying that a packet which is addressed to said active appliance and belongs to a new flow other than said existing flow is to be transferred to said second appliance.

6. A control method of a network in which a plurality of appliances and a switch are provided, one of said appliances being selected as an active appliance, wherein said switch contains a flow table, entries of which each specify an action to be performed on a packet matching with a matching condition, wherein, upon receiving a packet, said switch refers to said flow table and performs said action specified by matching one of said entries which matches said received packet, on said received packet, and wherein a first appliance of said appliances performing a first packet process on a packet belonging to an existing flow, when said first appliance is selected as said active appliance, said control method comprising:
switching said active appliance from said first appliance to a second appliance of said appliances,
wherein said switching includes:
performing a shortcut process; and
performing a switching process after said shortcut process,
wherein said shortcut process involves setting a first entry into said flow table in said switch, said first entry specifying that said first packet process is to be performed on a packet belonging to said existing flow, and
wherein said switching process involves setting a second entry into said flow table in said switch, said second entry specifying that a packet which is addressed to said active appliance and belongs to a new flow other than said existing flow is to be transferred to said second appliance.

7. A non-transitory recording medium recording a control program which when executed causes a computer to perform a control process of a network in which appliances and a switch are provided, one of said appliances being selected as an active appliance, wherein said switch contains a flow table,
entries of which each specify an action to be performed on a packet matching with a matching condition, wherein, upon receiving a packet, said switch refers to said flow table and performs said action specified by matching one of said entries which matches said received packet, on said received packet, and wherein a first appliance of said appliances performing a first packet process on a packet belonging to an existing flow, when said first appliance is selected as said active appliance,
said control process comprising:
switching said active appliance from said first appliance to a second appliance of said appliances,
wherein said switching includes:
performing a shortcut process; and
performing a switching process after said shortcut process,
wherein said shortcut process involves setting a first entry into said flow table in said switch, said first entry specifying that said first packet process is to be performed on a packet belonging to said existing flow, and
wherein said switching process involves setting a second entry into said flow table in said switch, said second entry specifying that a packet which is addressed to said active appliance and belongs to a new flow other than said existing flow is to be transferred to said second appliance.
